(19) United States
(12) Patent Application Publication
(10) Pub. No.: US 2013/0284788 A1
(43) Pub. Date: Oct. 31, 2013

(54) HAND-HELD WORK APPARATUS AND METHOD FOR OPERATING A HAND-HELD WORK APPARATUS

(71) Applicant: HILTI AKTIENGESELLSCHAFT, Schaan (LI)

(72) Inventors: Uwe GEROLD, Lindau (DE); Thorsten Sauer, Goefis (AT); Norbert Welte, Klaus (AT)

(73) Assignee: Hilti Aktiengesellschaft, Schaan (LI)

(21) Appl. No.: 13/861,482

(22) Filed: Apr. 12, 2013

(30) Foreign Application Priority Data
Apr. 25, 2012 (DE) 102012206761.2

(51) Int. Cl. B25C 1/08

(52) U.S. Cl. CPC B25C 1/08
USPC 227/147; 173/1

(57) ABSTRACT

The invention relates to a hand-held work apparatus for driving fastening elements into a substrate, wherein driving energy is released in the form of an impact to the fastening elements. In order to further simplify and/or improve the operation of the hand-held work apparatus, the work apparatus comprises a driving energy data device, by means of which data on the driving energy released in a previous driving process or in several previous driving processes can be communicated.

### CROSS-REFERENCE TO RELATED APPLICATIONS

This patent application claims the benefit of German Patent Application No. DE 102012206761.2, filed Apr. 25, 2012, which is incorporated by reference.

### TECHNICAL FIELD

The invention relates to a hand-held work apparatus for driving fastening elements into a substrate, wherein the driving energy is released in the form of an impact to the fastening elements. The invention further relates to a method for operating such a work apparatus.

### BACKGROUND OF THE INVENTION

German Offenlegungsschrift DE 103 03 006 A1 describes a work apparatus according to the preamble that has at least one sensor device for the acquisition of acceleration forces that occur during a setting or impact pulse, as well as an interface for data communication and/or for data output. From the German Patent Description DE 103 19 646 B3, a fuel-driven setting apparatus is known that comprises an ignition unit for propellants, a setting mechanism that can be driven by the propellant, and a recess for a driving propellant container, wherein the setting apparatus comprises a display for the reproduction of propellant filling level data of a propellant container located in a setting apparatus.

### BRIEF SUMMARY OF THE INVENTION

The task of the invention is to further simplify and/or to improve the operation of a hand-held work apparatus for driving fastening elements into a substrate, wherein the driving energy is released in the form of an impact to the fastening elements.

The task is solved, in the case of a hand-held work apparatus for driving fastening elements into a substrate, wherein the driving energy is released in the form of an impact to the fastening elements, in that the work apparatus comprises a driving power data device, by means of which the data on the driving energy released in a previous driving process or in several previous driving processes is communicated. The data is preferably communicated to a user or an operator of the hand-held work apparatus. Alternatively or additionally, the data can also be communicated, for example, by remote data transmission, from the hand-held work apparatus to nearly any location outside of the hand-held work apparatus. The work apparatus is preferably a hand-held work apparatus for setting bolts, and is operated with fuel gas. Therefore, the work device can also be referred to as a gas-operated bolt setting device or bolt thrusting tool. The fuel gas is supplied to an apparatus-internal combustion space, in which a combustible mixture is ignited, in order to drive a fastening element, such as a bolt or a nail, into a substrate. Using the invention, the operator or user of the hand-held work apparatus is informed, in a construction-site appropriate and simple way, what driving energy, particularly what driving energy quantity, was released by the hand-held work apparatus to the fastening element in at least one previous driving process. The data can be used particularly advantageously for evaluating the quality of a previous fastening. In addition, it is possible to check the correct functioning of the hand-held work apparatus in a simple manner. The user or operator of the hand-held apparatus is no longer reduced to his/her subjective impression in the operation of the work apparatus; instead he/she is informed reliably about the results of the previous driving process.

A preferred embodiment example of the hand-held work apparatus is characterized in that the driving energy data device outputs data on the driving energy steps. The driving energy quantity used in the previous driving process is advantageously determined and stored inside the apparatus. From the stored values, preferably on the basis of defined intervals, an energy step is calculated. It has been found to be advantageous to communicate the energy step in the operation of the work apparatus.

An additional preferred embodiment example of the hand-held work apparatus is characterized in that the data transmission of the driving energy data device is carried out visually, acoustically and/or haptically. For the visual data transmission, a display, preferably showing the respective energy step, is attached to the outside of the work apparatus such that it can be seen easily by the operator. In the acoustic data transmission, the user is informed, by means of different signal sounds, for example, whether a sufficient driving energy quantity has been released to the respective fastening element. In haptic data transmission, the user is informed by contact, for example, by vibrations of different strengths, preferably through a handle of the work apparatus, whether the energy released in a previous driving process was sufficient.

An additional preferred embodiment example of the hand-held work apparatus is characterized in that the work apparatus comprises a driving energy data storage device, by means of which the data on the driving energy released in a previous driving process or in several previous driving processes is stored. The data is preferably used apparatus-internally for the determination of the energy steps. Alternatively or additionally, the data can also be used for optimizing the current driving energy quantity.

An additional preferred embodiment example of the hand-held work apparatus according to the invention is characterized in that the work apparatus comprises a setting element that is in direct or indirect contact, via closed-loop control interactions, with the driving energy data device, in order to control or vary the driving energy quantity to be released in a current driving process. In the process, for example, a target driving energy quantity is compared to an actual driving energy quantity released in a previous driving process, in order to determine a control variable. The control variable is then used apparatus-internally to optimize the release of the driving energy.

In a method for operating an above-described hand-held work apparatus, the above-indicated problem is solved alternatively or additionally in that data on the driving energy released in a previous driving process or in several previous driving processes is released to the user or operator of the work apparatus. Using the invention, the operator or user of the hand-held work apparatus is informed, in a construction-site appropriate and simple way, what driving energy, particularly what driving energy quantity, was released by the hand-held work apparatus to the fastening element in at least one previous driving process. The data can be used particularly advantageously for evaluating the quality of the previous fastening. In addition, a simple way is provided to check the correct functioning of the hand-held work apparatus. The user or operator of the hand-held work apparatus is no longer reduced to his/her subjective impression in the operation of the work apparatus; instead he/she is informed reliably on the result of the previous driving process.

A preferred embodiment of the method is characterized in that the data on the driving energy released in a previous driving process or in several previous driving processes is communicated to the user or operator of the work apparatus visually, acoustically and/or haptically. As needed, the data can be communicated visually and acoustically, visually and haptically, acoustically and haptically, or particularly, acoustically and haptically.

An additional preferred embodiment of the method is characterized in that the data on the driving energy released in a previous driving process or in several previous driving processes is determined and/or stored apparatus-internally using at least one acceleration sensor. The data can then be used apparatus-internally not only for generating data, but also for controlling or regulating the driving energy release. If needed, the data can also be output per remote data transmission.

An additional preferred embodiment example of the method is characterized in that energy steps are determined from the data on the driving energy released in a previous driving process or in several previous driving processes. The use of the energy steps has been found to be advantageous in the operation of the hand-held work apparatus.

A further preferred embodiment example of the method is characterized in that a target driving energy quantity is compared to an actual driving energy quantity released in a previous driving process in order to determine a control variable. The control variable can be used advantageously apparatus-internally for optimizing the release of the driving energy to the fastening elements.

### BRIEF DESCRIPTION OF THE SEVERAL VIEWS OF THE DRAWING(S)

Further advantages, characteristics and details of the invention result from the following description, in which several embodiment examples are described in detail, with reference to the drawing.

FIG. 1 shows a simplified representation of a work apparatus according to the invention in cross section.

### DETAILED DESCRIPTION OF THE INVENTION

### Embodiment Examples

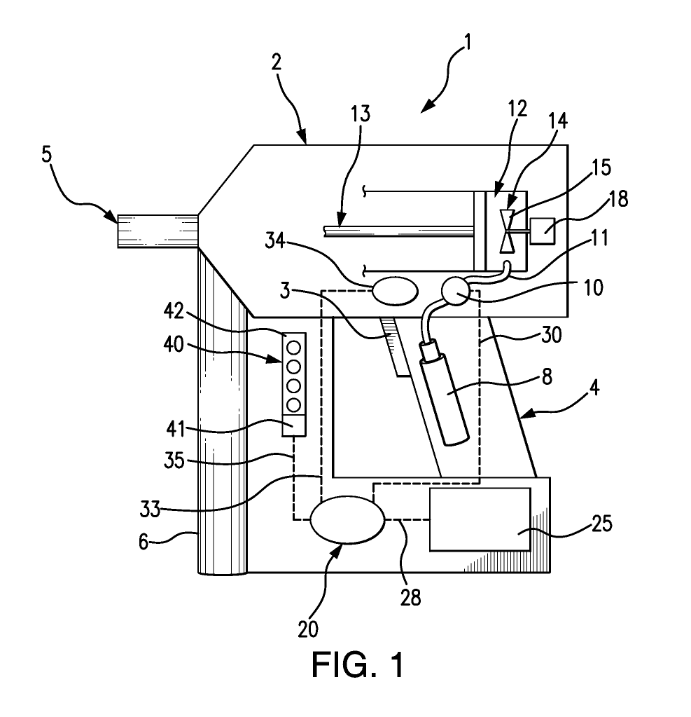

In FIG. 1, a work apparatus 1 with a housing 2 according to the invention is represented in a highly simplified manner. The work apparatus 1 is designed as a hand-held bolt setting apparatus with a handle 4 by which the bolt setting apparatus 1 can be held for driving a fastening element that, during the actuation of a trigger switch 3 at the bolt guide end 5, exits at the bolt guide end from the bolt setting apparatus 1 and is driven into a substrate.

The fastening elements used are preferably supplied via an apparatus-internal magazine 6 that is attached in the vicinity of the bolt guide end 5 of the bolt setting apparatus 1. From the magazine 6, the fastening elements are automatically removed, preferably individually, and made available at the bolt guide end 5.

The energy required for driving the fastening elements into the substrate is provided in a fuel container 8 in the interior of the bolt setting apparatus 1. The fuel container 8 preferably contains liquid fuel gas and is therefore also referred to as a gas container or a gas cartridge.

The fuel container 8 can be connected via an adjustable or variable dosing device 10 and a gas line 11 to a combustion chamber or a combustion space 12. The dosing device 10 preferably comprises a dosing valve, through which the gas quantity supplied to the fuel space can be controlled, for example, volumetrically or as a function of time.

In the combustion space 12, a fuel, particularly a gas, from the fuel container 8 is mixed with the air to form a combustible mixture which is then ignited in order to drive a fastening element, such as a bolt or a nail, into the substrate. The energy required for driving, for example, via a work piston 13, is transferred from the combustion chamber 12 to a fastening element at the bolt guide end 5.

In the combustion space 12, a device 14 is arranged that is used to generate turbulence in the combustion space 12 and to rinse and/or cool the combustion space 12. The device 14 comprises a ventilator 15 that is driven by an electromotor 18. The electromotor 18 is actuated by an electronic control device 20.

The work apparatus 1, also referred to as a gas apparatus, comprises moreover an electrical energy source 25 that is used, among other purposes, to supply the control device 20 with energy. For this purpose, the control device 20 is connected via a control and/or supply line 28 to the electrical energy source 25.

The dosing device 10 is also connected to the control device 20, via a control line 30. An acceleration sensor 34 is connected to the control device 20 via a signal line 33. The acceleration sensor 34 can comprise one acceleration sensor or several acceleration sensors.

A driving energy data device 40 is connected to the control device 20 via a control and/or supply line 35. The driving energy data device 40 comprises a first visual field 41 and a second visual field 42.

The first visual field 41 can be provided, for example, with a large letter, such as E, to indicate that, by means of the driving energy data device 40, data on the drive energy released by the work apparatus 1 is displayed. The second visual field 42 is used, for example, with the help of different light fields, to display energy steps, which depend on the released driving energy quantity.

In the work apparatus 1, which is also referred to as a bolt setting apparatus or bolt thrusting tool, the available driving energy is a particularly important parameter for the operation of the bolt thrust apparatus. This is especially true if a fastening point is to be produced that must reach certain minimum pullout forces.

An essential prerequisite is that the driving energy of the apparatus is adjusted in such a manner to the fastening element used that it is driven sufficiently deeply into the substrate. According to an aspect of the invention, reliable data on the driving energy of the work apparatus 1 released to the respective fastening element is communicated to the user or operator of the work apparatus 1.

For driving a fastening element into the substrate, a flammable gas mixture is ignited in the combustion space 12 of the work apparatus 1 so that the work piston 13 is accelerated by the expansion of the exhaust gas. The work piston 13 drives a suitable fastening element, such as a nail or a bolt, into the substrate.

During the work piston movement, the accelerator sensor 34 detects the acceleration of the work apparatus 1 itself. A corresponding acceleration signal is processed, for example, using a microprocessor, in the control device 20.

In the control device 20, the driving energy released by the work apparatus 1 is calculated, as a continuous parameter, for example, in Joule, preferably using an appropriate microprocessor device. The calculated driving energy and the measurement signal are stored electronically. From this, on the basis of defined intervals, an energy step is calculated.

The display of the achieved energy step occurs in an easily read visual manner in the second visual field 42 of the driving energy data device 40. The energy steps can be represented advantageously using LED or LCD displays. Thus, for example, four different steps can be displayed in a bar diagram.

Alternatively or additionally, the energy steps achieved can also be represented acoustically, for example, using a piezo loudspeaker. In the process, the individual energy steps can be represented by different numbers of signal sounds. In addition, the calculated driving energy can be used advantageously for the determination of a control variable that is used for controlling the dosing device 10, for example, via an appropriate setting element.

The advantages provided by the invention include the following. After each fastening with the work apparatus 1, the operator receives precise information on the driving energy that was achieved and thus can evaluate the quality of the fastening and the proper functioning of the gas apparatus 1. The user is no longer limited to his/her subjective impression; instead, he/she is informed reliably on the result of a previous setting process on the basis of a precise measurement.

The work apparatus 1 can be set in a simple manner automatically for an optimal fastening. The storage of the determined energy values also allows a diagnosis of the apparatus output in the event of maintenance and/or repair. Data transmission to an external storage system can be used advantageously for the systematic analysis of the apparatus energies achieved. In addition, the transmitted data can be used by an apparatus manufacturer for optimizing the development of the apparatus.

1. A hand-held work apparatus for driving fastening elements into a substrate, wherein the driving energy is released in the form of an impact to the fastening element, comprising a driving energy data device, by means of which data on the driving energy released in a previous driving process or in several previous driving processes is transmitted.

2. The hand-held work apparatus according to claim 1, wherein the driving energy data device outputs data on the driving energy released.

3. The hand-held work apparatus according to claim 2, wherein the data transmission of the driving energy data device occurs visually, acoustically and/or haptically.

4. The hand-held work apparatus according to claim 1, further comprising a driving energy data storage device, by means of which data on the driving energy released in a previous driving process or in several previous driving processes is stored.

5. The hand-held work apparatus according to claim 1, comprising a setting element that is directly or indirectly in a closed-loop control interaction with the driving energy data device in order to control or regulate the driving energy quantity to be released in a current driving process.

6. A method for operating a hand-held work apparatus according to claim 1, comprising communicating data on the driving energy released in a previous driving process or in several previous driving processes to a user or operator of the work apparatus.

7. The method according to claim 6, comprising visually, acoustically and/or haptically communicating data on the driving energy released in a previous driving process or in several previous driving processes to the user or operator of the work apparatus.

8. The method according to claim 6, comprising determining and/or storing data on the driving energy released in a previous driving process or in several previous driving processes using at least one acceleration sensor.

9. The method according to claim 8, comprising determining energy steps from the data on the driving energy released in a previous driving process or in several previous driving processes.

10. The method according to claim 6, comprising comparing a target driving energy quantity to an actual driving energy quantity released in a previous driving process in order to determine a control variable.

11. The hand-held work apparatus according to claim 2, further comprising a driving energy data storage device, by means of which data on the driving energy released in a previous driving process or in several previous driving processes is stored.

12. The hand-held work apparatus according to claim 3, further comprising a driving energy data storage device, by means of which data on the driving energy released in a previous driving process or in several previous driving processes is stored.

13. The hand-held work apparatus according to claim 2, comprising communicating a setting element that is directly or indirectly in a closed-loop control interaction with the driving energy data device in order to control or regulate the driving energy quantity to be released in a current driving process.

14. The hand-held work apparatus according to claim 3, comprising communicating a setting element that is directly or indirectly in a closed-loop control interaction with the driving energy data device in order to control or regulate the driving energy quantity to be released in a current driving process.

15. The hand-held work apparatus according to claim 4, comprising communicating a setting element that is directly or indirectly in a closed-loop control interaction with the driving energy data device in order to control or regulate the driving energy quantity to be released in a current driving process.

16. The method according to claim 7, comprising determining and/or storing data on the driving energy released in a previous driving process or in several previous driving processes using at least one acceleration sensor.

17. The method according to claim 7, comprising comparing a target driving energy quantity to an actual driving energy quantity released in a previous driving process in order to determine a control variable.

18. The method according to claim 8, comprising comparing a target driving energy quantity to an actual driving energy quantity released in a previous driving process in order to determine a control variable.

19. The method according to claim 18, comprising comparing a target driving energy quantity to an actual driving energy quantity released in a previous driving process in order to determine a control variable.
